(19) United States
(12) Patent Application Publication
(10) Pub. No.: US 2026/0216906 A1
(43) Pub. Date: Jul. 30, 2026

(54) Bread slicer with a protective screen

(71) Applicant: JAC S.A., Liège (BE)

(72) Inventor: Baudouin Van Cauwenberghe, Liège (BE)

(21) Appl. No.: 19/454,586

(22) Filed: Jan. 21, 2026

(30) Foreign Application Priority Data
Jan. 21, 2025 (BE) 2025/5044

(51) Int. Cl. B26D 7/22; B26D 1/11; B26D 7/06; B26D 7/24

(52) U.S. Cl. CPC B26D 7/225; B26D 1/11; B26D 7/0608; B26D 7/24; B26D 2210/06

(57) ABSTRACT

A bread slicer with a frame including a loading compartment, an output table for receiving the sliced loaf of bread, a blade assembly extending between the loading compartment and the output table, a push rod making it possible to push the loaf of bread through the blade assembly, a movable bread press for clamping the loaf of bread between the bottom of the loading compartment and the bread press when the loaf of bread passes through the blade assembly. The bread press can form a protective screen extending into the loading compartment opposite the blades between the blade assembly and the push rod.

The invention relates to a bread slicer for cutting a loaf of bread into slices. More specifically, it relates to a slicer that is often placed in stores where it is used by customers to slice a loaf of bread.

Such a slicer includes a loading compartment for receiving a loaf of bread to be sliced, with an access opening for placing the loaf at the bottom of the compartment. The sliced bread is received on an output table.

To cut the loaf into slices, the slicer features a blade assembly with oblong blades arranged substantially parallel to one another, which can be driven in a reciprocating motion in their longitudinal direction. The blade assembly extends between the loading compartment and the output table.

A push rod that is parallel to the blade assembly is provided in the loading compartment. This push rod pushes the loaf in a direction of movement from the loading compartment through the blade assembly towards the output table. Thus, the push rod is movable between a retracted position, in which the push rod is positioned on the side of the loading compartment opposite to that of the blade assembly, and a forward position in which the push rod extends across the blade assembly.

In addition, the slicer is also equipped with a movable bread press to clamp the loaf between the bottom of the loading compartment and the bread press itself as the bread to be sliced passes through the blade assembly. The bread press can move between a resting position and a raised position and features fingers that can move between the blades of the blade assembly in response to the movement of the bread press. The movement of the bread press from the resting position to the raised position is driven by the loaf as it is pushed against the bread press by the push rod while the loaf passes through the blade assembly.

In such slicers, the unsliced bread must be inserted into the loading compartment by a user through the access opening. In doing so, the user risks pushing against the bread press and getting into contact with the sharp edges of the blades with his/her hands, which could cause injury. This is especially true when the user inadvertently drops an object into the compartment and attempts to retrieve it.

The invention aims to solve this problem by providing a bread slicer with which the risk of contact between the consumer's hands and the sharp edges of the blades is virtually nonexistent.

To this end, the bread press forms a protective screen in said resting position of the bread press by extending at least partially into the loading compartment opposite the blades, between the blade assembly and the push rod, which is in said retracted position. The slicer according to the invention comprises a locking device that allows the bread press to be locked in the resting position to form said protective screen.

Advantageously, the slicer includes safety features that allow it to operate in a secure mode during the reciprocating motion of the blades, wherein the moving blades are not accessible to a user through the loading compartment, and a non-secure mode wherein a loaf of bread to be sliced can be introduced into the loading compartment through this access opening. The aforementioned locking device is then set to automatically lock the bread press in the resting position in said non-secure mode.

According to a particular embodiment of the invention, the locking device is controlled by the movement of the push rod such that, when the push rod is moved towards the bread press, the bread press is automatically released from its resting position, and when the push rod is placed in its retracted position, the bread press is automatically locked in its resting position by the locking device.

According to an interesting embodiment of the invention, the locking device comprises a rigid member that mechanically connects the bread press to an anchoring base when the bread press is in its resting position and the push rod is in said retracted position. This anchoring base comprises the push rod or the slicer frame.

According to a preferred embodiment of the invention, the rigid member is mounted to pivot around a spindle extending essentially transversely with respect to said direction of movement and preferably parallel to the plane of the blade assembly. This rigid member has a hook that is designed to catch a rod extending parallel to said spindle. The rod is provided on the bread press or on the anchoring base, respectively, while the rigid member is mounted on the anchoring base or on the bread press, respectively.

In an interesting manner, the rigid member extends laterally relative to the loading compartment.

In an alternative embodiment of the slicer according to the invention, the slicer includes a cover for closing the access opening. The locking device is then controlled by the movement of the cover such that, when the cover is closed, the bread press is released from its resting position, and when the cover is opened while the push rod is in its retracted position, the bread press is locked in the resting position by the locking device.

The invention also relates to a method for securing the access to the slicer blades. In this method, when the bread press is in the resting position and the push rod is in said retracted position, the bread press is automatically locked in the resting position to form a protective screen extending into the loading compartment opposite the blades of the blade assembly.

Other details and particularities of the invention will become apparent from the following description, given by way of non-limiting example, of some specific embodiments of the machine and the method according to the invention with reference to the attached drawings.

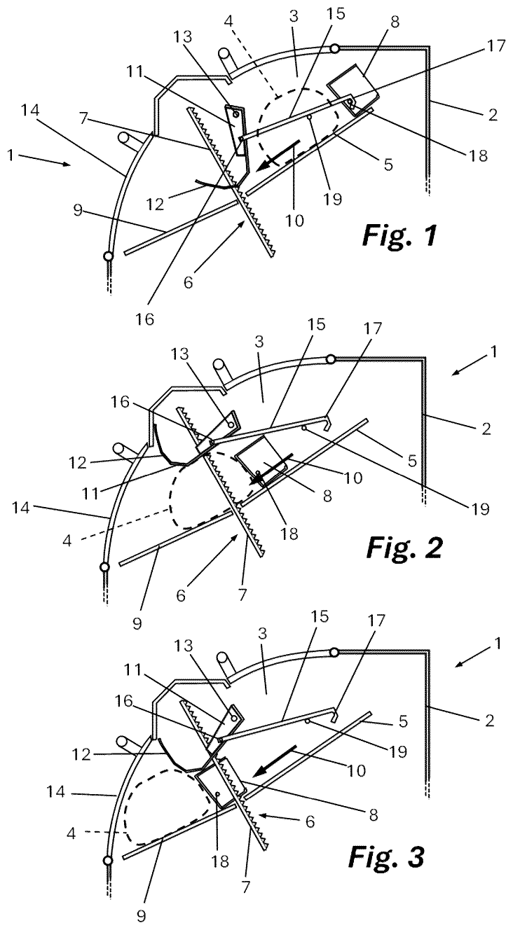

FIGS. 1 to 3 show a highly schematic representation of a side view of the slicer according to a preferred embodiment of the invention.

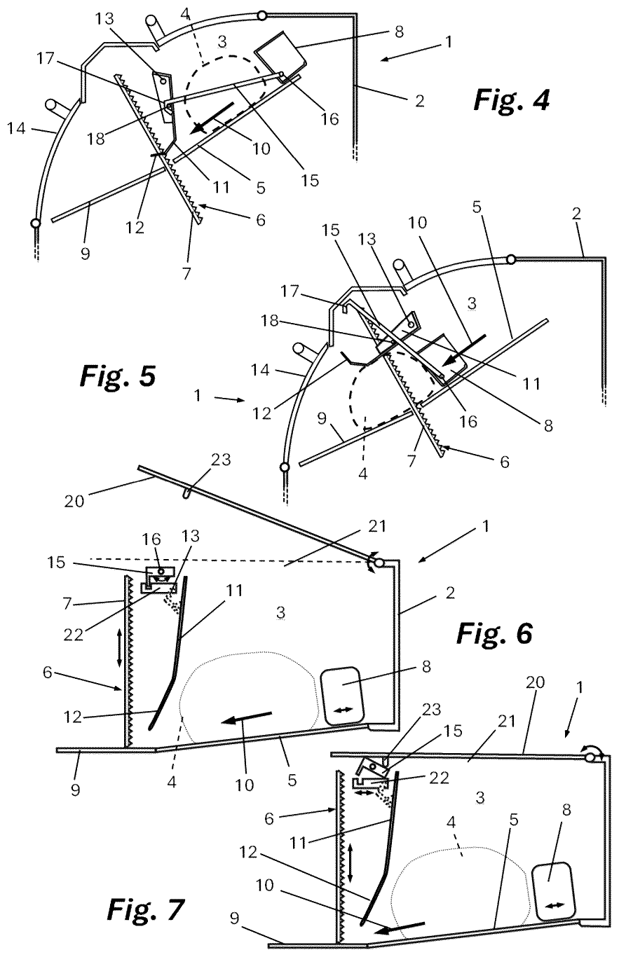

FIGS. 4 and 5 show a highly schematic representation of a side view of the slicer according to an alternative embodiment of the invention.

FIGS. 6 and 7 show a highly schematic representation of a side view of the slicer according to an interesting embodiment of the invention.

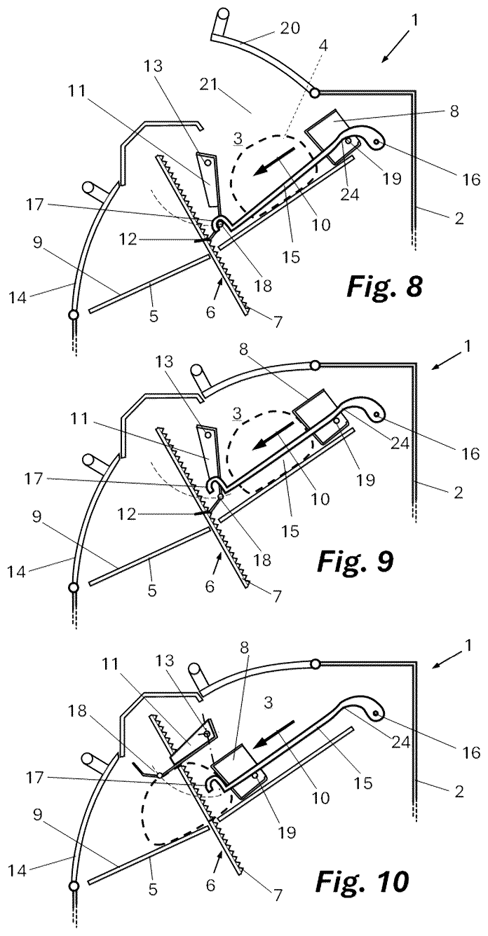

FIGS. 8 to 10 show a highly schematic representation of a side view of the slicer according to yet another embodiment of the invention.

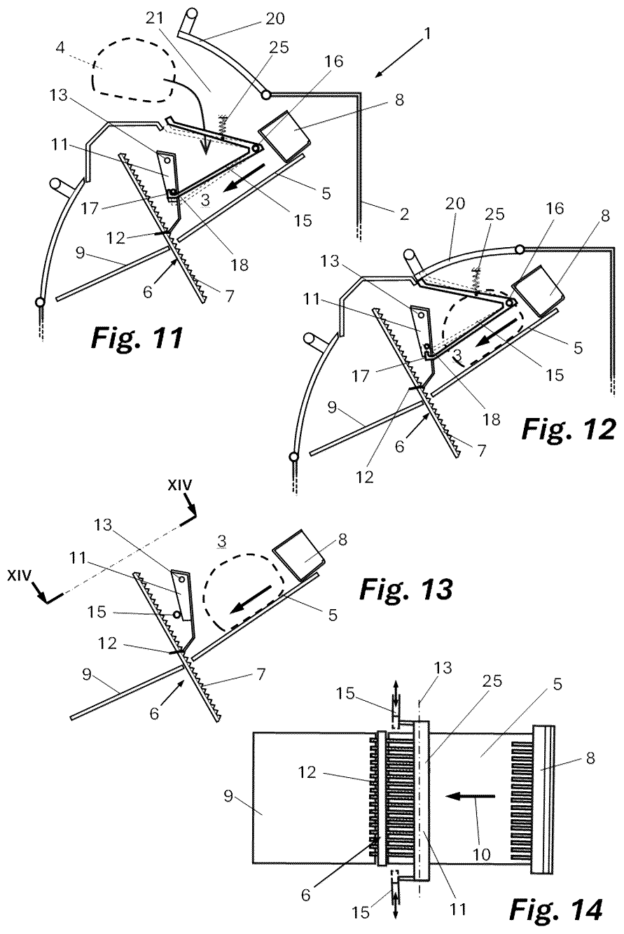

FIGS. 11 and 12 show a highly schematic representation of a side view of the slicer according to another interesting embodiment of the invention in which the locking device is controlled by the movement of the slicer's cover.

FIG. 13 is a highly schematic side view of the slicer according to yet another embodiment of the invention.

FIG. 14 is a schematic top view of the slicer according to the invention, along line XIV-XIV of FIG. 13.

In the different figures, the same reference numerals refer to similar or identical elements.

The invention generally relates to a bread slicer comprising a loading compartment for a loaf of bread to be sliced, which is connected to an output table for receiving the sliced bread. A blade assembly extends between the loading compartment and the output table. A push rod is present in the loading compartment to push the bread through the blade assembly. During this movement of the loaf towards the output table, it is clamped between the bottom of the loading compartment and a movable bread press. The bread press prevents the loaf from moving vertically or tearing under the effect of the blades'movement during slicing, thus ensuring a high-quality cut.

The first embodiment of the slicer according to the invention is schematically represented in FIGS. 1 to 3. The slicer 1 comprises a frame 2 having a loading compartment 3 for receiving a loaf of bread 4 to be sliced. To slice a loaf of bread 4, the loaf is placed on the bottom 5 of the loading compartment 3 of the slicer 1. A blade assembly 6 extends directly next to this compartment 3 and is used to slice the loaf of bread 4.

The blade assembly 6 comprises a series of oblong blades 7 arranged substantially parallel to one another and which can be driven in a reciprocating motion in their longitudinal direction. Preferably, the blades 7 of the blade assembly 6 each extend along a vertical plane. The blade assembly 6 defines a plane that extends perpendicularly to the blades 7 and parallel to the longitudinal direction of these blades 7.

In the loading compartment 3 is provided a push rod 8 which is driven to push the loaf 4 from the loading compartment 3 through the blade assembly 6 towards an output table 9 in the direction of movement indicated by arrow 10. The blade assembly 6 is therefore positioned between the loading compartment 3 and the output table 9. A loaf 4 to be sliced is placed on the bottom 5 of the loading compartment 3 between the push rod 8 and the blade assembly 6, as shown in FIG. 1.

The push rod 8 preferably extends across the entire width of the loading compartment 3 and parallel to the plane defined by the blade assembly 6. The push rod 8 can be driven in the direction of movement 10 of the loaf to push the loaf 4 through the blade assembly 6. Preferably, the front side of the push rod 6 facing the blade assembly 4 has elongated, parallel recesses or slots into which the blades 7 of the blade assembly 6 can be inserted. Thus, the front side of the pusher 8 can pass beyond the blade assembly 6, as illustrated in FIG. 3, to push the sliced bread through the blade assembly 6 until it lies entirely on the output table 9 from where the sliced bread is collected by the consumer.

Thus, the push rod 8 is movable between a retracted position, in which the push rod 8 is positioned on the side of the loading compartment 3 opposite that of the blade assembly 6, and a forward position in which the push rod 8 extends through the blade assembly 6. The retracted position of the push rod 8 is shown in FIG. 1, while in FIG. 3, the push rod 8 is in the forward position.

The direction of movement of the loaf of bread 10 is generally parallel to the bottom 5 of the loading compartment 3 and/or parallel to the lateral faces of the blades 7 that are part of the blade assembly 6.

The slicer 1 also includes a movable bread press 11 for pressing the loaf 4 against the bottom 5 of the loading compartment 3 as the loaf 4 to be sliced passes through the blade assembly 6. Thus, the loaf 4 is held between the bottom 5 and the bread press 11 during slicing. This ensures that the slices are of excellent quality.

The bread press 11 can move between a resting position and a raised position and has fingers 12 that can move between the blades 7 of the blade assembly 6 in response to the movement of the bread press 11. The bread press is mounted so that it can rotate around a fixed spindle 13 relative to the frame, which is parallel to the blade assembly 6.

In FIG. 1, the bread press 11 is shown in its resting position, while in FIG. 2, the bread press is in its raised position. The movement of the bread press 11 from its resting position to its raised position is driven by the loaf of bread 4 when it is pushed against the bread press 11 by the push rod 8 while the loaf of bread 4 passes through the blade assembly 6. As the loaf of bread 4 moves in the direction of movement 10, the bread press rotates around the fixed spindle 13 from its resting position to the raised position. During this movement of the bread press 11, the latter exerts slight pressure on the loaf of bread to prevent it from deforming or tearing upon contact with the blades 7, which are driven by their reciprocating motion.

When the bread press 11 rests on the top of the bread 4, as shown in FIG. 2, the bread press 11 is in the raised position. As the push rod 8 continues to move, thereby advancing the loaf of bread 4, the direction of movement of the bread press 11 is reversed until the bread press 11 rests on the push rod 8 and the loaf is completely sliced, as shown in FIG. 3.

The sliced loaf 4 is then collected from the output table 9 by the consumer after opening the door 14 that provides access to this output table 9. Once the sliced loaf has been retrieved, the push rod 8 is returned to the retracted position and the bread press 11 automatically moves to the resting position, as shown in FIG. 1.

When the bread press 11 is in said resting position, it forms a protective screen that extends into the loading compartment 3 opposite the blades 7 between the blade assembly 6. According to the invention, the slicer includes a locking device that allows the bread press 11 to be locked in the resting position when the push rod 8 is in the retraction position.

By locking the bread press 11 in this resting position, as shown in FIG. 1, a user placing a loaf of bread 4 into the loading compartment 3 is protected from making contact with the blades 7 by the presence of the bread press 11, whose position is locked and which thus forms a protective screen in the loading compartment 3 opposite the blade assembly 6.

In the embodiment of the invention shown in FIGS. 1 to 3, the locking device comprises a rigid member 15 that allows the bread press 11 to be mechanically connected to an anchoring base when the bread press 11 is in the resting position and the push rod 8 is in said retracted position. This anchoring base is formed by the push rod 8 of the slicer shown in FIGS. 1 to 3.

The rigid member 15 is mounted to pivot around a spindle 16 provided in the bread press 11. The spindle 16 extends transversely with respect to the direction of movement 10 and is preferably located on the lateral side of the bread press 11.

Preferably, the rigid member extends laterally with respect to the loading compartment 3 so as not to obstruct the introduction of a loaf of bread 4 in the loading compartment 3 and not to hinder the slicing of the loaf 4.

The rigid member 15, shown in FIGS. 1 to 3, has a hook 17 designed to catch a rod 18 extending parallel to said spindle 16. This rod 18 is provided at said anchoring base, specifically at the push rod 8. The hook 17 is preferably provided at the end of the rigid member opposite the end of the pivoting spindle 16.

When the bread press 11 is in its resting position and the push rod 8 is in its retracted position, the rigid member 15 mechanically connects the bread press 11 to the push rod 8, thus locking the bread press in place. In particular, the bread press 11 cannot move toward the blades 7 due to this mechanical connection.

As soon as the push rod 8 is moved in the aforementioned direction of movement 10, the hook 17 disengages from the rod 18, allowing the bread press to move towards the blade assembly 6 and into its raised position due to the movement of the loaf of bread 4, as shown, for example, in FIGS. 2 and 3.

To prevent the rigid member 15 from dropping uncontrollably, a guide pin 19 is provided. The rigid member 15 is supported by the guide pin 19 while the push rod 8 moves between the forward position and the retracted position.

After the sliced loaf 4 has been removed from the output table, the push rod 8 is returned to its retracted position. Following this movement to the retracted position, the hook 17 of the rigid member 15 is engaged by the rod 18 such that the bread press 11 is once again locked in its resting position and thus forms a protective shield, as shown in FIG. 1.

The rigid member 15 may be made of a rigid metal strip and may, for example, be shaped like a curved cane.

FIGS. 4 and 5 show a variant of the previous embodiment of the slicer according to the invention, in which the rigid member 15 is mounted to pivot around a spindle 16 that is fixed relative to the push rod 8.

In this embodiment, the hook 17 of the rigid member 15 of the locking device cooperates with a rod 18 that is fixed relative to the bread press 11. Thus, when the bread press 11 is in the resting position and the push rod 8 is in the retracted position, as shown in FIG. 4, the bread press 11 is locked and cannot move towards the blade assembly.

As soon as the push rod 8 is driven in the direction of movement 10 towards the blade assembly 6, the hook 17 disengages from the rod 18 and is then supported and guided by the latter as the push rod 8 advances. FIG. 5 shows the bread press 11 in its raised position while the rigid member 15 is supported by the rod 18 which thus forms a guide pin.

FIGS. 6 and 7 illustrate yet another embodiment of the invention, in which the locking device cooperates with a cover 20 of the slicer 1. This cover 20 allows an access opening 21 to be opened or closed to access the loading compartment 3. The locking device is controlled by the movement of the cover 20 such that, when the cover 20 is closed, the bread press 11 is released from its resting position, and when the cover 20 is opened while the push rod 8 is in its retracted position, the bread press 11 is locked in its resting position by the locking device.

To this end, the cover cooperates with a rigid member formed by a latch 15 that can move around a spindle 16 fixed relative to the frame 2 of the slicer 1. This latch 15 engages with a sliding bolt 22 that is fixed to the bread press 11. When the latch is engaged with the sliding bolt 22, this sliding bolt 22 cannot move, such that the bread press 11 is locked in its resting position, as shown in FIG. 6. This is the case when the cover 20 of the slicer is open.

When the cover 20 is closed, a stop 23 provided on the inner side of the cover 20 pushes against the latch 15 so that the latch 15 pivots around the spindle 16 and disengages from the sliding bolt 22, as shown in FIG. 7. Thus, the bread press 11 is released and can move from its resting position to the raised position when slicing a loaf of bread.

Therefore, when the cover 20 is opened by a user while the bread press 11 is in the resting position and the push rod 8 is in the retracted position, the stop is raised and the latch 15 automatically engages with the sliding bolt 22 to secure the bread press 11.

FIGS. 8 to 10 illustrate yet another embodiment of the slicer according to the invention, in which the locking device comprises a rigid member 15 that mechanically connects the bread press 11 to the slicer's frame 2 when the bread press 11 is in the resting position and the push rod 8 is in the aforementioned retracted position.

This rigid member 15 is pivotally mounted around a spindle 16 extending essentially transversely with respect to the direction of movement 10, as is the case in the embodiments of the slicer described above. In the embodiment of the invention shown in FIGS. 8 to 10, one end of the rigid member 15 is thus secured by means of the spindle 16 to an anchoring base formed by the frame 2 of the slicer 1. The end of the rigid member 15 opposite the spindle 16 has a hook 17 which is designed to catch a rod 18 extending parallel to the aforementioned spindle 16. This rod 18 is provided on the bread press 11.

In FIG. 8, the rigid member 15 is shown when the bread press 11 is in its resting position and the push rod 8 is in its retracted position. The hook 17 of the rigid member is attached to the rod 18, which forms a whole with the bread press 11. The hook 17 is open at the bottom so that by moving the rigid member upwards, the hook can be disengaged from the rod 18.

The push rod 8 can move between the spindle 16 of the rigid member 15 and the blade assembly 6. A guide pin 19, forming a roller to guide and support the rigid member 15, is fixed to the lateral end of the push rod 8.

The underside of the rigid member 15 has an inclined surface 24 at the location of the pin 19. When the rigid member 15 is hooked onto the rod 18, the distance between said surface 24 and the bottom 5 of the loading compartment 3 decreases in the direction of movement 10 from the pin 19 of the push rod which is in the retracted position. In particular, this distance is less than the distance between the upper side of the guide pin 19 and the bottom 5. Thus, when the push rod 8 is moved towards the blade assembly 6 to slice a loaf of bread 4, the rigid member 15 is lifted by the guide pin 19 and thereby rotates around the spindle 16, so that the hook 17 disengages from the rod 18, as shown in FIG. 9. Thus, the bread press 11 is released following the movement of the push rod 8 towards the blade assembly 6.

The push rod 11 continues to move towards the blade assembly 6 so that the loaf of bread is pushed against the bread press 11, which moves to its raised position as the loaf 4 is pushed through the blade assembly 6, as shown in FIG. 10.

After the sliced loaf has been retrieved by a user, the push rod 8 is returned to the retraction position and the bread press 11 returns to its resting position, so that the hook 17 re-engages with the rod 18 and the bread press 11 is locked in this resting position.

FIGS. 11 and 12 illustrate an embodiment of the slicer according to the invention, in which the rigid member 15 is controlled by opening or closing the cover 20. When the cover 20 is open, the rigid member 15 engages, by means of a hook 17, with a rod 18 fixed laterally to the bread press 15, which is then in the resting position, so that the bread press 11 is locked in this resting position. The rigid member 15 is mounted so as to pivot around a spindle 16 that is fixed relative to the frame 2 of the slicer.

As shown in FIG. 12, when the cover 20 is closed, it presses against the rigid member 15 against the action of a spring 25. In this position of the rigid member 15, the hook 17 does not catch the rod 18 provided on the bread press 11. When the cover 11 is opened to place a loaf of bread in the loading compartment 3, the rigid member rotates around the spindle 16 as a result of the action of the spring 25, making the hook 17 catch the rod 18 to lock the bread press 11 in the resting position. This is illustrated in FIG. 11.

When the cover 20 is then closed again, it pushes against the rigid member 15, which is moved against the action of the spring 25 until the hook 17 disengages from the rod 18 to release the bread press 11.

FIGS. 13 and 14 show yet another embodiment of the slicer according to the invention, in which a rigid member 15 cooperates with an electromechanical system, such as an electric motor. The rigid member 15 has the shape of a rod that extends transversely with respect to the direction of movement 10 and can be moved in its longitudinal direction as it is driven by the electromechanical system. The rigid member 15, i.e., the rod in question, is positioned between the plane of the blade assembly 6 and the bread press 11 when the latter is in its resting position. To lock the bread press 11 in this resting position in order to form a protective screen, the rigid member 15 is moved until it is located in the path of the bread press 11 between the bread press and the plane of the blade assembly 6.

Preferably, the electromechanical system that drives the rigid member 15 is controlled by the opening and closing of the cover 20. When the cover 20 is open, the rigid member 15 is moved along the path of the rigid member so that the latter is locked in the resting position.

When the cover is closed, the rigid member is removed from the path of the bread press to release it.

The slicers according to the invention generally also include safety features that allow the machine to operate in a secure mode during the reciprocating motion of the blades 7, whereby the moving blades 7 are not accessible to a user through the loading compartment 3, and in a non-secure mode in which a loaf of bread 4 to be sliced can be introduced into the loading compartment 3 through said access opening 21. Thus, while a loaf of bread is being sliced, the slicer is in the secure mode. In this secure mode, the door 14 and the cover 20 are, for example, locked to prevent a user from accessing the moving parts of the slicer such as, for example, the blades 7. According to the invention, the aforementioned locking device of the slicer is designed to automatically lock the bread press 11 in the resting position in the non-secure mode of the slicer 1 to prevent the user from making contact with the blades 7, as described above for some embodiments of the invention.

In the embodiment of the slicer according to the invention, shown in FIGS. 1 to 3, the fingers of the bread press extend on the opposite side of the blade assembly 6 with respect to the loading compartment 3, such that when the push rod 8 partially passes through the blade assembly 6 after a loaf of bread 4 has been completely sliced, and the bread press 11 rests on the push rod, these fingers 12, together with the push rod 8, form a protective screen extending opposite the blades 7 of the blade assembly 6 and above the output table 9. This is shown in FIG. 3. Therefore, a user who wishes to retrieve a sliced loaf of bread from the output table 9 cannot touch the blades 7 thanks to the presence of this protective screen formed by the fingers 12 and the push rod 8.

It is clear that, according to the invention, a locking device for securing the bread press 11 can be provided on a single side of the loading compartment or it can be provided on either side of the compartment.

In most embodiments of the slicer according to the invention described above, the bread press is mounted so as to pivot around a spindle 16 that is fixed relative to the frame 2, but it is also possible for this spindle 16 to be free-floating relative to the frame 2. Thus, in certain slicers according to the invention, the bread press 11 may undergo a translation or a combination of a translation and a rotation during its movement between the resting position and the raised position.

1. A bread slicer with a frame comprising:
a loading compartment having a base for receiving a loaf of bread to be sliced, said compartment being provided with an access opening for placing a loaf of bread to be sliced onto said base,
an output table for receiving the sliced loaf of bread,
a blade assembly comprising oblong blades arranged substantially parallel to one another, and which can be driven in a reciprocating motion in their longitudinal direction, wherein the blade assembly extends between the loading compartment and the output table and is designed for slicing a loaf of bread,
a push rod extending substantially parallel to the blade assembly and configured to push the loaf of bread in a direction of movement from the loading compartment through the blade assembly towards the output table, the push rod being movable between a retracted position, in which the push rod is positioned on the side of the loading compartment opposite that of the blade assembly, and a forward position in which the push rod extends through the blade assembly,
a movable bread press for clamping the loaf of bread between the bottom of the loading compartment and the bread press as the loaf of bread to be sliced passes through the blade assembly, the bread press being able to move between a resting position and a raised position and having fingers that can move between the blades of the blade assembly as a result of the movement of the bread press, the movement from the resting position to the raised position being driven by the loaf of bread when it the loaf of bread is pushed against the bread press by the push rod while the loaf of bread passes through the blade assembly,
wherein, in said resting position of the bread press, the bread press forms a protective screen extending at least partially into the loading compartment opposite the blades between the blade assembly and the push rod which is in said retracted position, and the slicer includes a locking device for locking the bread press in the resting position.

2. The bread slicer according to claim 1, comprising safety means allowing to operate in a secure mode during the reciprocating motion of the blades in which the moving blades are not accessible to a user through the loading compartment, and a non-secure mode in which a loaf of bread to be sliced can be introduced into the loading compartment through said access opening, whereby said locking device is designed to automatically lock the bread press in the resting position in said non-secure mode.

3. The bread slicer according to claim 1, wherein the locking device is controlled by the movement of the push rod (8) such that, when the push rod is moved towards the bread press, the bread press is released from the resting position and, when the push rod is placed in its retracted position, the bread press is locked in the resting position by the locking device.

4. The bread slicer according to claim 1, wherein the locking device comprises a rigid member for mechanically connecting the bread press to an anchoring base when the bread press is in its resting position and the push rod is in said retracted position, said anchoring comprising the push rod or the slicer's frame.

5. The bread slicer according to claim 4, in which the rigid member is mounted to pivot around a spindle extending substantially transversely with respect to said direction of movement, said rigid member having a hook designed to catch a rod extending parallel to said spindle, said rod being provided on the bread press or on the anchoring base, respectively, whereas the rigid member is mounted on the anchoring base or on the bread press, respectively.

6. The bread slicer according to claim 4, comprising a guide pin for supporting said rigid member while the push rod moves between said forward position and the retracted position.

7. The bread slicer according to claim 4, wherein the rigid member has the shape of a curved cane.

8. The bread slicer according to claim 4, wherein the rigid member extends laterally to the loading compartment.

9. The bread slicer according to claim 1, comprising a cover for closing the access opening, the locking device being controlled by the movement of the cover such that, when the cover is closed, the bread press is released from the resting position and, when the cover is opened while the push rod is in its retracted position, the bread press is locked in the resting position by the locking device.

10. The bread slicer according to claim 9, wherein the locking device comprises a rigid member for automatically locking the bread press relative to the frame of the slicer when the bread press is in the resting position and the cover is open.

11. The bread slicer according to claim 1, wherein the bread press is mounted such that the bread press can pivot around a spindle fixed relative to the frame, said spindle being parallel to the plane of the blade assembly.

12. The bread slicer according to claim 1, wherein the fingers of the bread press extend from the side of the blade assembly opposite the loading compartment such that, when the push rod partially passes through the blade assembly after a loaf of bread has been completely sliced and the bread press rests on the push rod, the fingers, together with the push rod, form a protective screen extending opposite the blades of the blade assembly and above the output table

13. The bread slicer according to claim 1, wherein the locking device extends substantially laterally from the loading compartment and, preferably, outside said compartment.

14. A method for securing the access to the blades of a bread slicer, said slicer comprising:
a loading compartment having a base for receiving a loaf of bread to be sliced, said compartment being provided with an access opening for placing a loaf of bread to be sliced onto said base,
an output table for receiving the sliced loaf of bread,
a blade assembly comprising oblong blades arranged substantially parallel to each other, and which can be driven in a reciprocating motion in their longitudinal direction, said blade assembly extending between the loading compartment and the output table,
a push rod extending substantially parallel to the blade assembly and allowing the loaf of bread to be pushed in a direction of movement from the loading compartment through the blade assembly towards the output table, the push rod being movable between a retracted position, in which the push rod is positioned on the side of the loading compartment opposite that of the blade assembly, and a forward position in which the push rod extends through the blade assembly,
a movable bread press for clamping the loaf of bread between the bottom of the loading compartment and the bread press as the loaf of bread to be sliced passes through the blade assembly, said bread press being able to move between a resting position and a raised position and having fingers that can move between the blades of the blade assembly as a result of the movement of the bread press, the movement from the resting position to the raised position being driven by the loaf of bread when the loaf of bread is pushed against the bread press by the push rod while the loaf of bread passes through the blade assembly,
the method comprising, when the bread press is in the resting position and the push rod (8) is in said retracted position, automatically locking the bread press in the resting position to a form a protective screen extending in the loading compartment opposite the blades of the blade assembly.

15. The method according to claim 14, wherein the bread press is locked in the resting position by connecting the bread press to an anchoring base by a rigid member, said anchoring base comprising the push rod or the frame of the slicer.
